(19) United States
(12) Patent Application Publication
(10) Pub. No.: US 2026/0001600 A1
(43) Pub. Date: Jan. 1, 2026

(54) CONTROLLING A MAGNET ARRAY IN A VEHICLE

(71) Applicant: Boston Engineering Corporation, Waltham, MA (US)

(72) Inventors: Steven James Simas, Amherst, NH (US); Michael Conry, Salem, MA (US); Michael Rufo, Hanover, MA (US); David J. Shane, Woburn, MA (US)

(21) Appl. No.: 19/251,490

(22) Filed: Jun. 26, 2025

Related U.S. Application Data
(60) Provisional application No. 63/664,501, filed on Jun. 26, 2024.

(51) Int. Cl. B62D 57/024; G01L 5/00; H01F 7/20

(52) U.S. Cl. CPC B62D 57/024; G01L 5/00; H01F 7/202

(57) ABSTRACT

A vehicle for driving on ferromagnetic structures includes a chassis, first and second wheels rotatably coupled to the chassis, and a magnet array coupled to the chassis for magnetically attracting the vehicle to the structures. The magnet array is controllable to aim a magnetic field produced by the magnet array over a range of angles relative to the chassis.

### CROSS-REFERENCE TO RELATED APPLICATIONS

This application claims the benefit of U.S. Provisional Application No. 63/664,501, filed Jun. 26, 2025, the contents and teachings of which are incorporated herein by reference in their entirety.

### BACKGROUND

This disclosure relates generally to vehicles, and more particularly to vehicles designed for driving over ferromagnetic structures, such as steel floors, walls, and/or ceilings.

Magnetic crawlers are essential equipment for inspecting tanks and other materials while driving over steel and other iron-based surfaces, such as those commonly found in maritime surface vessels and submarines. Such magnetic crawlers are typically ROVs (remotely operated vehicles) equipped with cameras for inspection and navigation. The crawlers are typically small vehicles designed to navigate tight spaces that are difficult for humans to reach, and which in some cases are too dangerous for humans to enter.

As their name implies, magnetic crawlers typically contain magnets that attract the crawlers to the ferromagnetic surfaces over which the crawlers are driven. Such magnets not only improve traction but also enable the vehicles to climb walls and traverse ceilings.

One type of magnetic crawler employs a fixed magnet attached to the chassis of the crawler. The magnet applies downforce to hold the crawler firmly to a surface on which the crawler is being driven. Another type of magnetic crawler provides a circular array of magnets disposed inside one or more wheels of the crawler. The magnets in the wheels are arranged to rotate along with the wheels that contain them, such that some of the magnets are always close to the surface being driven on and can provide a magnetic downforce that holds the vehicle against the surface.

### SUMMARY

Unfortunately, prior magnetic crawlers are limited in their ability to direct downforce induced by the magnets. Magnets mounted to the chassis of a crawler can pull straight down but cannot pull strongly forward or backward, causing the crawler to resist transitions between different surfaces, such as between floors and walls, or between walls and ceilings. Magnets mounted within wheels can direct downforce radially from the wheels, but the strength of the downforce is limited by the small number of magnets that happen to be close to the surface being pulled. Also, wheels placed in corners between different surfaces can pull in two different directions at once, meaning that a crawler may need to work against the force one magnet in order to move from one surface to the next. What is needed, therefore, is a magnetic crawler with a magnet array that can be oriented toward ferromagnetic surfaces independently of the orientation of the vehicle and in a single direction at a time.

The above need is addressed at least in part with an improved technique in which a magnet array is controllable to articulate relative to a vehicle such that a downforce from the magnet array can be aimed in a single direction over a wide range of angles, which include an angle aimed below the vehicle and an angle aimed in front of and/or behind the vehicle.

Advantageously, the improved technique enables the vehicle to handle transitions between different surfaces effectively by controlling the direction of magnetic downforce. Not only can this approach facilitate transitions between floors and walls and between walls and ceilings, but it can also handle transitions among irregular surfaces, including passageways between different tanks or containers.

Certain embodiments are directed to a vehicle for driving on ferromagnetic structures. The vehicle includes a chassis, first and second wheels rotatably coupled to the chassis, and a magnet array coupled to the chassis for magnetically attracting the vehicle to the structures. The magnet array is controllable to aim a magnetic field produced by the magnet array over a range of angles relative to the chassis.

Other embodiments are directed to a method of operating a vehicle having a chassis, first and second wheels rotatably coupled to the chassis, and a moveable magnet array. The method includes driving the vehicle along a horizontal surface of a ferromagnetic structure with the magnet array facing the horizontal surface and attracting the vehicle to the horizontal surface. Upon the first and second wheels contacting a vertical surface of the ferromagnetic structure, the method further includes rotating the magnet array to face the vertical surface and to attract the vehicle to the vertical surface, and driving the vehicle up the vertical surface with the magnet array continuing to face the vertical surface.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is an isometric view of an example vehicle in which embodiments of the improved technique can be practiced.

FIG. 2 is an isometric view of an underside of the vehicle of FIG. 1 showing magnet arrays according to one or more embodiments.

FIG. 3 is an isometric cross-sectional view of a magnet array of FIG. 2 disposed within and between two wheels of the vehicle, according to one or more embodiments.

FIG. 4 is an isometric view of portions of the vehicle of FIGS. 1 and 2 showing a magnet array that includes an anti-rotation bar, according to one or more embodiments.

FIG. 5 is a front plan view of a magnet array including individual magnets, according to one or more embodiments.

FIG. 6 is a front isometric view of a fixture used to assemble the magnet array of FIG. 5, according to one or more embodiments.

FIG. 7 is an isometric view of a manufacturing station used to manufacture the magnet array of FIG. 5, according to one or more embodiments.

FIGS. 8A-8F are simplified side elevation views of the vehicle of FIGS. 1 and 2 navigating different surfaces, according to one or more embodiments.

FIG. 9 is a flowchart showing an example method of operating a vehicle, such as the vehicle of FIGS. 1 and 2, according to one or more embodiments.

### DETAILED DESCRIPTION

An improved technique provides a vehicle having a magnet array that is controllable to articulate relative to a vehicle chassis such that a downforce from the magnet array can be aimed in a single direction over a wide range of angles, which include an angle aimed below the vehicle and an angle aimed in front of and/or behind the vehicle. For example, when the vehicle is driven along a horizontal floor, the magnet array can be aimed downwardly to pull the vehicle against the floor. When the vehicle then approaches a vertical wall, the magnet array can be aimed straight ahead, toward the wall, thereby providing downforce against the wall and enabling the vehicle to climb the wall easily.

According to one or more embodiments, the angle of the articulating magnet array may be controlled using any combination of manual control and automatic control. For example, a human operator can use a remote controller to aim a magnet array, e.g., by observing the environment of the vehicle using a video feed received from one or more on-board cameras of the vehicle. As another example, the magnet array can be aimed automatically, e.g., by using on-board electronics to measure a downforce produced by the magnet array and to vary the angle of the magnet array so as to maximize the measured downforce. Any combination of manual control and automatic control may be applied.

According to one or more embodiments, the magnet array is constructed and arranged to rotate about an axis, and the axis intersects a pair of wheels of the vehicle. For example, the axis may intersect an axle that connects the pair of wheels.

In a typical arrangement, the vehicle includes four wheels, two in the front of the vehicle and two in the rear. A first magnet array is disposed at the front of the vehicle within and between the front wheels, and a second magnet array is disposed at the rear of the vehicle within and between the rear wheels. In some examples, tracks may be provided around the wheels on respective sides (e.g., left and right). However, other examples do not employ tracks.

According to one or more embodiments, the magnet array includes an anti-rotation bar arranged to extend backwards or forwards from the vehicle and to selectively lock at right angles to the magnet array. When locked, the anti-rotation bar resists backward rotation of the vehicle when climbing over surfaces and obstacles.

Embodiments of the improved technique will now be described. One should appreciate that such embodiments are provided by way of example to illustrate certain features and principles but are not intended to be limiting.

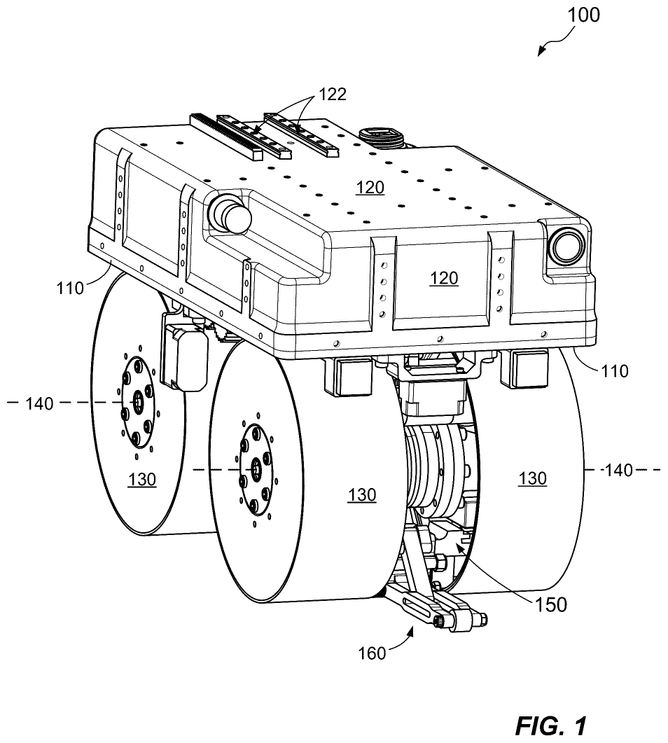

FIG. 1 shows an example vehicle 100 according to one or more embodiments. The vehicle 100 includes a chassis 110, a cover 120, and wheels 130. Various electronics, motors, and gears may be mounted to the chassis 110, and various sensors may be mounted to the cover 120. The sensors may include one or more cameras and LIDAR (light detection and ranging) sensors to assist with navigation. The cover 120 may further include an adapter 122 for attaching to a robotic inspection arm (not shown), which may be useful for inspecting tanks, containers, and other items around the vehicle 100.

The chassis 110 is mechanically coupled to the wheels 130, e.g., through gears, bearings, and the like. Four wheels 130 are shown, two in the front of the vehicle 100 and two in the rear. In some examples, the terms “front” and “rear” are merely conventions, as the vehicle 100 may be driven equally well both forwards and backwards.

In an example, respective motors independently drive each of the wheels 130. Although not required, the motors are preferably electric and are powered by line voltage over a power cord or by a battery located inside the vehicle 100. In the example shown, the wheels 130 are non-steerable, and the driving direction of the vehicle 100 is changed using skid steering.

According to one or more embodiments, the vehicle 100 is a remotely operated vehicle (ROV), which can be controlled by a human operator. To that end, the vehicle 100 may contain communication circuitry and processing capabilities for receiving commands from a remote control station and for providing output to the remote control station, such as video feeds, sensor data, and the like. The communication circuitry may support wired and/or wireless communications, such as Wi-Fi or Bluetooth.

According to one or more embodiments, the vehicle 100 further includes a magnet array 150 disposed within and between at least one pair of wheels 130, e.g., the front wheels, as shown. Preferably, a separate magnet array is also disposed within and between the rear wheels.

Taking the labeled front magnet array 150 as an example, the magnet array 150 is constructed and arranged to articulate such that it can point in multiple directions. For example, the magnet array 150 can be aimed straight down to attract the vehicle 100 to a ferromagnetic floor beneath the vehicle 100, or it can be aimed straight forward to attract the vehicle 100 to a ferromagnetic wall in front of the vehicle 100. The magnet array 150 is preferably controlled independently of the wheels 130, such that it can maintain a constant direction of aim regardless of whether the vehicle 100 is moving or standing still. A rear magnet array (if provided) operates in a similar manner, and it is able to aim straight down or straight back.

In an example, each magnet array 150 is constructed and arranged to swing about a respective transverse axis 140, which intersects the adjacent pair of wheels 130. In the arrangement shown, each transverse axis 140 is colinear with a rotational axis of the adjacent wheels 130, such that both the adjacent wheels 130 and the associated magnet array 150 are arranged to rotate/swing about the same axis.

According to one or more embodiments, the magnet array 150 includes an anti-rotation bar 160. The anti-rotation bar 160 is arranged to assume one of a locked condition and an unlocked condition. When locked, the anti-rotation bar 160 is held at a right angle to the magnet array 150. When unlocked, the anti-rotation bar 160 is free to fold back between the adjacent wheels 130. As explained more fully below, the anti-rotation bar 160 resists backward rotation of the vehicle 100 when the vehicle is navigating certain obstacles. Anti-rotation bars 160 may be provided in both magnet arrays (front and rear), or just in one magnet array 150.

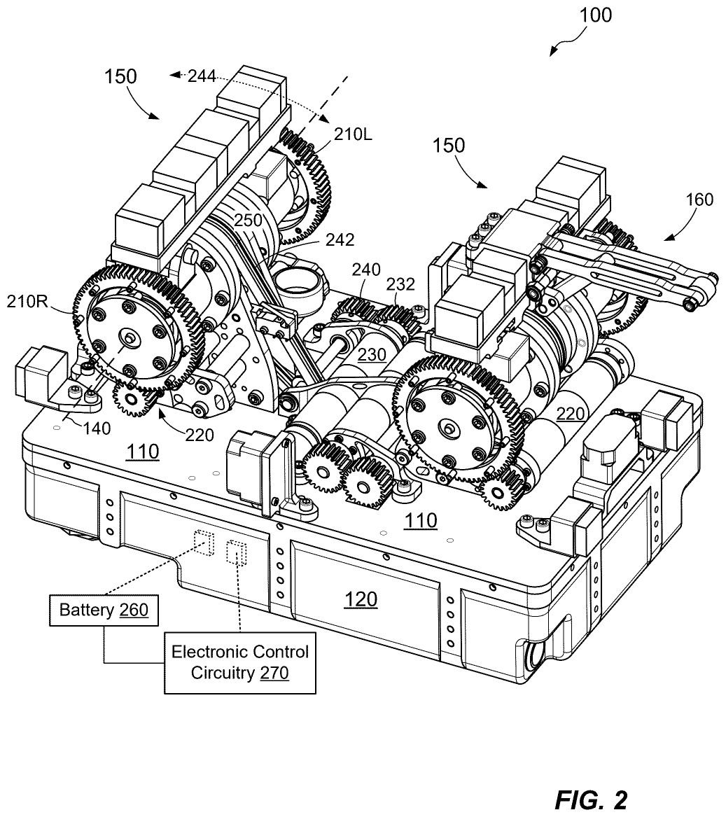

FIG. 2 shows an underside of the vehicle 100 with the wheels 130 removed for improved visibility, according to one or more embodiments. Both front and rear magnet arrays 150 are shown. As best seen to the left of the figure, the rear magnet array 150 is offset from the associated axis 140 such that the magnet array 150 is able to swing through an arc 244 centered on the axis 140. Drive sprockets 210R and 210L for right and left wheels 130 are coupled to respective motors 220, which are individually controllable, e.g., for individually driving forward, stopping, reversing, etc.

According to one or more embodiments, a separate motor 230 is provided for driving the magnet array 150. The motor 230 is coupled to a gear 232, which meshes with a gear assembly 240. The gear assembly 240 drives a chain or belt 242, which wraps around a central hub 250. The central hub 250 is attached to the magnet array 150. In this manner, rotation of the motor 230 results in corresponding rotation of the central hub 250, which swings the magnet array 150 along the arc 244 about the axis 140. Rotation of the motor 230 in one direction causes the magnet array 150 to swing clockwise, and rotation of the motor 230 in the opposite direction causes the magnet array 150 to swing counterclockwise. Preferably, a chain 242 rather than a belt is used between the gear assembly 240 and the central hub 250, as a chain is better able to withstand expected forces without slipping. Although not shown, respective sets of teeth may be provided on both the gear assembly 240 and the central hub 250 for engaging with the chain 242. While the above description refers mainly to the rear magnet array, which is shown to the left, similar principles apply to the front magnet array, which is shown to the right.

As further shown in FIG. 2, a battery 260 as well as electronic control circuitry 270 may be housed within the body 120, such as on an internal side of the chassis 110. The electronic control circuitry 270 may include the above-mentioned communication circuitry, as well as control loops, motor drivers for controlling the motors 220, 230, and other circuitry generally needed for operation of the vehicle 100.

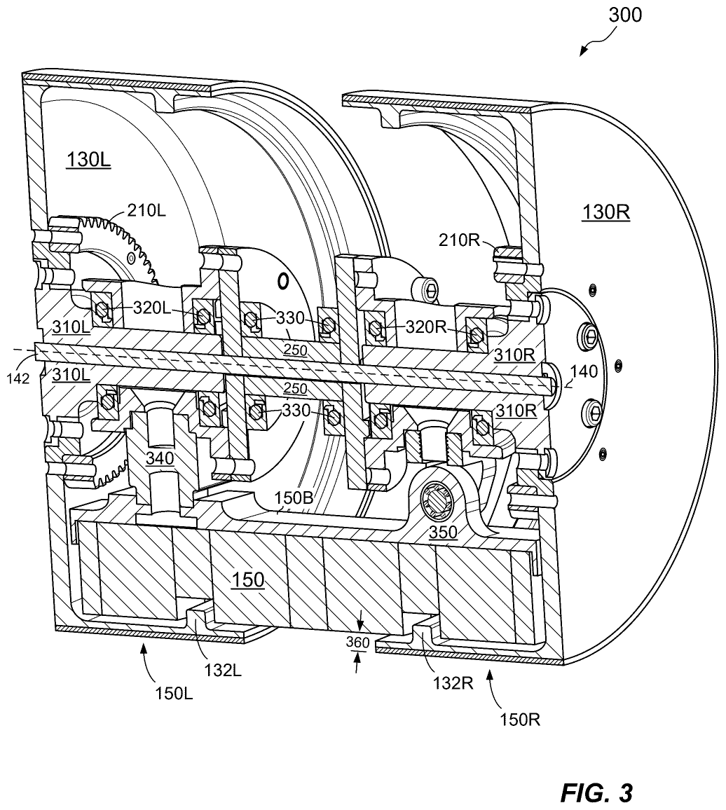

FIG. 3 is a cross-sectional view of a wheel assembly 300 of the vehicle 100 taken along the axis 140 of FIG. 2, according to one or more embodiments. Left and right wheels 130L and 130R are separately labeled, as well as associated left and right drive sprockets 210L and 210R. The drive sprockets 210L and 210R (gears) may be mounted directly to the respective wheels 130L and 130R. An axle 142 runs along the axis 140 and includes a cap (not shown) at each end to hold the wheels 130L and 130R onto the vehicle 100. As shown, the left and right drive sprockets 210L and 210R are screwed onto the left and right wheel hubs 310L and 310R, respectively, and the wheel hubs 310L and 310R are arranged to rotate on left and right bearing assemblies, 320L and 320R, respectively. In addition, the central hub 250 (FIG. 2) is arranged to rotate on a central bearing assembly 330. One should appreciate that rotation of the central hub 250 is independent of the rotations of the wheel hubs 310L and 310R, and that rotations of the wheel hubs 310L and 310R are independent of each other. As the central hub 250 rotates, the magnet array 150, shown at the bottom of FIG. 3, swings correspondingly, based on the illustrated structures that connect the central hub 250 to the magnet array 150.

The above-described connecting structures include a load cell 340, shown to the left of FIG. 3, and a pin joint 350, shown to the right. In the example shown, both the load cell 340 and the pin joint 350 are attached to a plate 150B, which also provides a base plate for the magnet array 150. In the illustrated example, the magnet array 150 is suspended from the central hub 250 by the load cell 340 on one end and the pin joint 350 on the other end.

The load cell 340 is arranged to measure a downforce induced by the magnet array 150, and the pin joint 350 is arranged to pivot about a single axis that allows the load cell 340 to expand and contract under changing downforce conditions. The pin joint 350 is further arranged to resist all other rotations and translations. In the illustrated arrangement, the downforce imposed by the magnet array 150 divides approximately equally between the load cell 340 and the pin joint 350, enabling the load cell 340 to produce an output signal proportional to the downforce. The output signal from the load cell 40 electrically routed to the electronic control circuitry 270 (FIG. 2).

According to one or more embodiments, the output signal from the load cell 340 provides an input to a control loop, e.g., housed in the electronic control circuitry 270, that controls the motor 230 (FIG. 2) and thus controls the angle of the magnet array 150. The control loop is arranged to repeatedly measure the downforce based on the output signal from the load cell 340 and to adjust the angular position of the motor 230 in such a way as to maximize the measured downforce. In this manner, the control loop can orient the magnet array 150 at whichever angle produces the greatest downforce. Although this automatic control loop provides one approach for orienting the magnet assembly 150, other approaches may also be used, such as one in which a human operator of a remote control station rotates the magnet array 150 manually by entering commands into the remote controller. In addition, both manual and automatic control can be turned off, and the magnet arrays can be allowed to passively orient themselves approximately to the angle of greatest downforce.

As further shown in FIG. 3, the magnet array 150 is at least partially disposed within the wheels 130L and 130R. In particular, a first end 150L of the magnet array 150 is disposed within the left wheel 130L and a second end 150R of the magnet array 150 is disposed within the right wheel 130R. Given the depicted example in which the wheels 130L and 130R rotate about the same axis 140 as the central hub 250, a radial distance 360 between the magnet array 150 and the outermost extents of the wheels 130L and 130R remains constant regardless of the angle of the magnet array 150. Preferably, this radial distance 360 is as short as practicable, given that magnetic downforce decreases strongly with distance from a ferromagnetic surface, which would be located against the outsides of the wheels. As a design target, the radial distance 360 between the outermost extent of the magnet array 150 and the outermost extents of the wheels 130L and 130R is 10 millimeters or less, and ideally it is approximately 5 millimeters or less. These are just examples, however, and the disclosure is not limited to any particular radial distance 360.

According to one or more embodiments, the wheels 130 are composed of a stiff, non-ferrous material, such as aluminum or hard plastic, and the outer contact surfaces of the wheels may be coated with a thin layer of rubber to provide extra grip. Stiffening ribs 132L and 132R may be provided for strength.

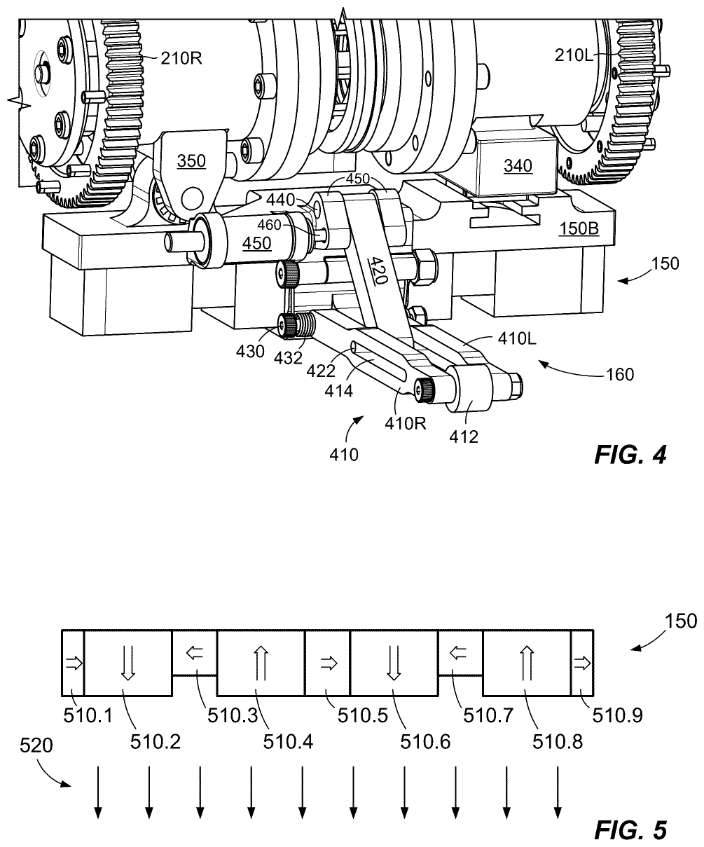

FIG. 4 shows portions of an example magnet array 150 and associated components in greater detail, according to one or more embodiments. Here, the magnet array 150 is equipped with an anti-rotation bar 160. As described further below, the anti-rotation bar 160 acts to resist backward rotation of the vehicle 100 when the vehicle 100 is navigating certain obstacles.

The anti-rotation bar 160 includes an arm 410 having a proximal end that connects to the magnet array 150 via a hinge 430. A spring 432, such as a torsion spring, is arranged to bias the arm 410 in its down (deployed) position, in which the arm 410 extends at approximately a right angle (90 degrees) from the magnet array 150. In an example, a small wheel 412 is attached to a distal end of the arm 410 to reduce drag and scraping when the arm 410 is deployed.

In the example shown, the arm 410 includes left and right sides 410L and 410R which are laterally separated by an opening. The opening is arranged to receive a stop 420, which terminates in left and right tabs 422 arranged to slide back in forth within respective channels 414. In some examples, the tabs 422 can be realized using a pin pressed through a transverse hole in the stop 420.

A locking mechanism is shown at a proximal end of the stop 420. Here, a post 440 is passed through holes in standoffs 450 and a hole (not visible) in the proximal end of the stop 420 to provide a hinge joint. When unlocked, the stop 420 is able to rotate about the post 440. To lock the anti-rotation bar 160, a solenoid 450 is arranged to extend a locking pin 460 through additional holes in the standoffs 450 and through another transverse hole (not visible) in the stop 420. The locking pin 460 prevents the stop 420 from rotating about the post 440 and thus firmly holds the arm 410 at a right angle to the magnet array 150.

When the solenoid 450 deactivates, the locking pin 460 retracts, unlocking the stop 420 and enabling the arm 410 to rotate upwardly into a space between the left and right wheels. As the stop 420 rotates upwardly, the tabs 422 slide down the channels 414 in the arm 410. Given that the spring 432 biases the arm 410 to the down position, any upward rotation of the arm 410 would normally be temporary as the vehicle drives over terrain which pushes up on the arm 410.

Preferably, the solenoid 450 operates based on control signals from the electronic control circuitry 270 (FIG. 2). Such control signals may be issued in response to commands from a remote human operator or automatically, for example.

FIG. 5 shows the magnet array 150 in additional detail according to one or more embodiments. Here, the magnet array 150 is realized as a Halbach array composed of nine individual magnets, 510.1 through 510.9. The magnets 510.1 through 510.9 have respective sizes and magnetic orientations, with the illustrated arrows indicating respective magnetic North directions.

Magnets of four different sizes are used, as follows:
Magnets 510.1 and 510.9 have dimensions 1.0 inch by 1.0 inch by 0.25 inch (2.54 cm by 2.54 cm by 0.63 cm).
Magnets 510.2, 510.4, 510.6, and 510.8 have dimensions 1.0 inch by 1.0 inch by 1.0 inch (2.54 cm by 2.54 cm by 2.54 cm).
Magnets 510.3 and 510.7 have dimensions 1.0 inch by 1.0 inch by 0.5 inch (2.54 cm by 2.54 cm by 1.27 cm).
Magnet 510.5 has dimensions 1.0 inch by 0.75 inch by 0.5 inch (2.54 cm by 1.91 cm by 1.27 cm).
   Suitable examples of magnets 510.1 through 510.9 include neodymium N52 magnets. The array layout was selected based on FEMM (Finite Element Method Magnetics) simulations and empirical testing, with the aim of maximizing magnetic downforce. The array 150 produces a magnetic field 520 that extends primarily in a single direction and attracts ferromagnetic structures and materials disposed in the magnetic field 520. Aiming the array 150 straight down causes the magnetic field to be directed straight down, and aiming the array 150 forward or back causes the magnetic field to be directed directly forward or back.

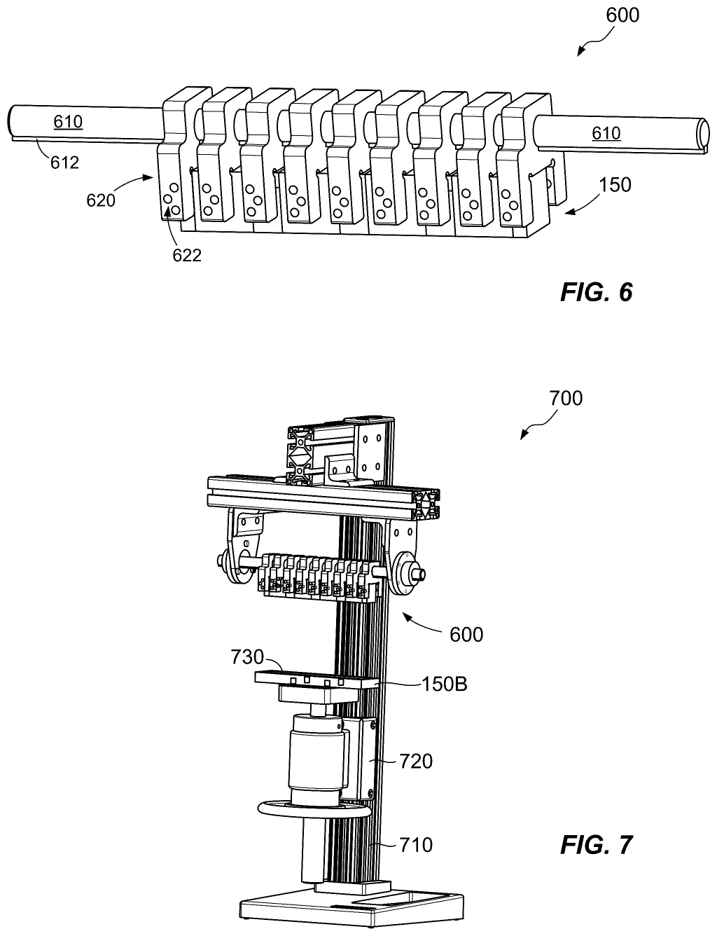

FIG. 6 shows an example fixture 600 for aligning the individual magnets 510.1 through 510.9 of the magnet array 150. External constraints may be needed to align the individual magnets in the arrangement shown, as the magnets naturally tend to reorient themselves at angles that do not achieve the desired effect of maximizing downforce. According to one or more embodiments, such constraints are achieved using a keyed rail 610 and respective holders 620, e.g., one holder 620 per magnet. As shown, a holder 620 includes a hole for receiving the rail 610, and the hole 610 has an alignment notch for receiving a key 612 of the keyed rail 610. In addition, the holder 620 includes holes 622 for receiving set screws (not shown), which firmly engage with a magnet to keep the magnet within the holder 620. With this arrangement, individual magnets 510.1 through 510.9 may be placed in the holders 620 and the holders 620 may be slid onto the keyed rail 610. The magnets may then be pressed together without the risk that they will rotate out of their proper orientations.

FIG. 7 shows an example manufacturing station 700 for assembling the magnet array 150. In this example, the fixture 600 is loaded with the magnets 510.1 through 510.9 (FIG. 6) and held in the orientation shown. The baseplate 150B (FIGS. 3 and 4) is placed on a carriage 720 configured to travel up and down along a column 710. The baseplate 150B includes a cavity 730, which is filled with liquid epoxy resin. In this arrangement, the carriage 720 is raised until the magnets 510.1 through 510.9 enter the cavity 730 and penetrate to the bottom of the cavity 730, which causes the liquid epoxy to surround the magnets. The epoxy is allowed to cure in this position, fixing the magnets in place and affixing the magnets to the base plate 150B. Once the epoxy is cured, the magnets with the attached base plate 150B are removed from the manufacturing station 700, the holders 620 are removed, and excess epoxy is trimmed or otherwise removed. The magnet array 150 may then be installed in the vehicle 100, e.g., as shown in FIG. 4.

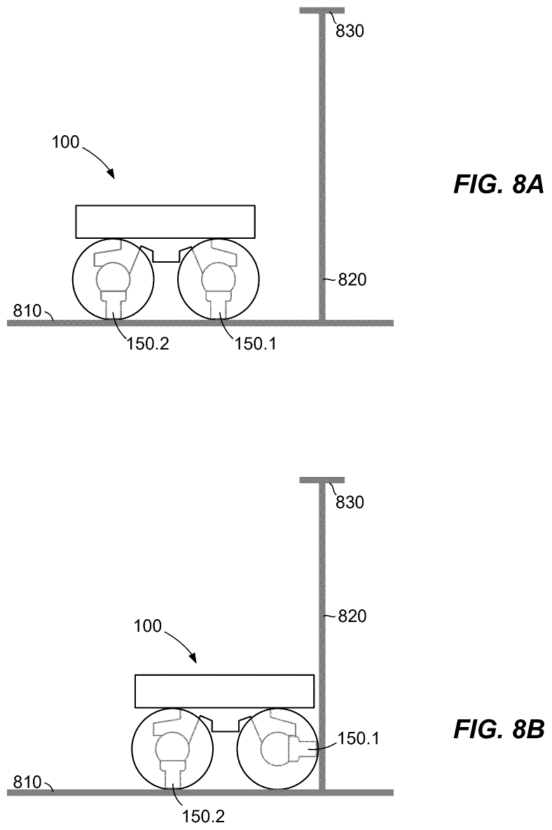

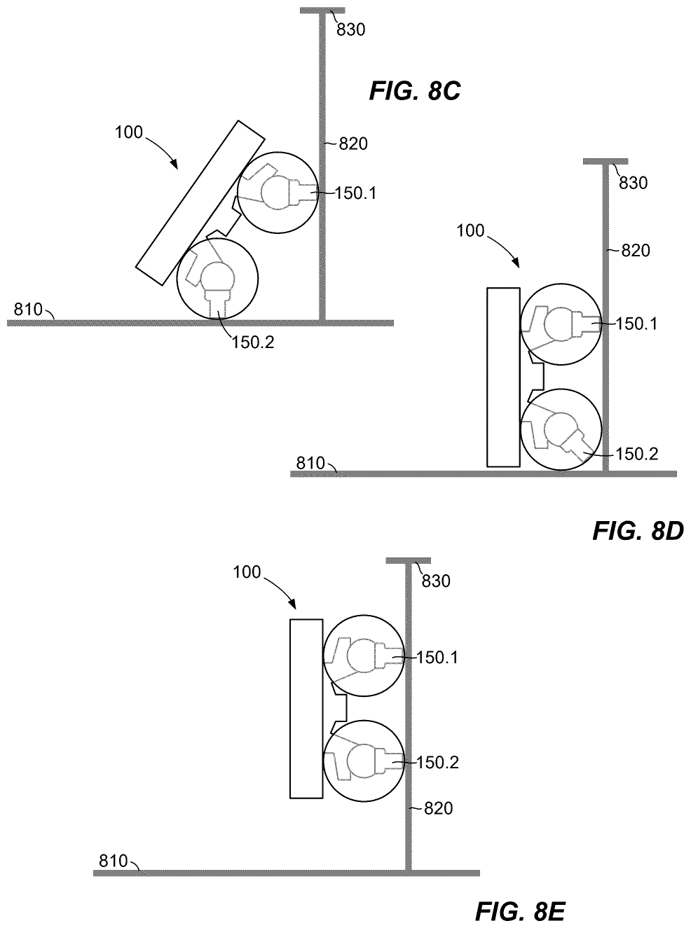

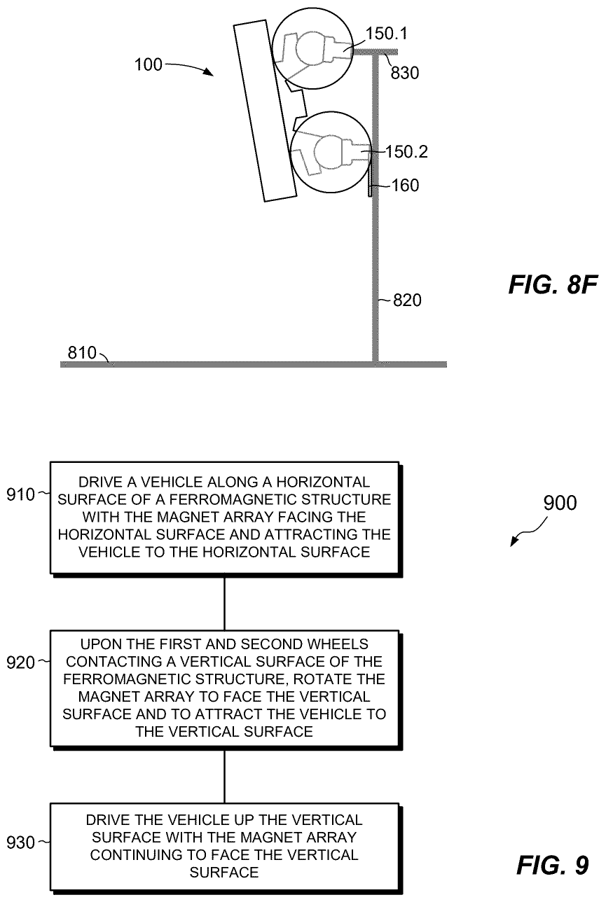

FIGS. 8A through 8F show examples in which the vehicle 100 is operated for traversing walls and obstacles, according to one or more embodiments. Each of these figures shows an environment that includes a horizontal floor 810, a vertical wall 820, and an obstacle 830. These examples assume that the vehicle 110 has two magnet arrays 150.1 and 150.2, i.e., one magnet array 150.1 in the front of the vehicle 100 and another magnet array 150.2 in the rear of the vehicle 100.

In FIG. 8A, the vehicle 100 is driven along the floor 810. In this condition, both magnet arrays 150.1 and 150.2 are aimed straight down, to maximize magnetic downforce directed toward the floor 810.

In FIG. 8B, the vehicle 100 has reached the wall 820. Assume now that a remote operator of the vehicle 100 wishes to have the vehicle 100 climb up the wall 820. The operator directs vehicle 100 to orient the front magnetic array 150.1 forward, as shown, to maximize downforce directed toward the wall 820. One should appreciate that rotating the magnet array 150.1 horizontally in this example involves a deliberate operation, as the magnet array 150.1 would normally continue to aim straight down, i.e., toward a local maximum of downforce.

In FIG. 8C, the vehicle 100 begins climbing the wall 820. In this condition, the front magnet array 150.1 directly faces the wall 820 (e.g., toward a local maximum of downforce), while the rear magnet array 150.2 faces directly down. It is noted that keeping the magnet arrays pointed to the respective surfaces is a dynamic process, which is preferably handled by the above-described control loop, which continually adjusts the angles of the magnet arrays to maximize downforce.

In FIG. 8D, the rear wheels have reached the wall 820. In this example, the rear magnet array 150.2 is shown in an intermediate state as it transitions from a downward-facing angle to a forward-facing angle. For example, the remote operator may direct the rear magnet array 150.2 to rotate horizontally, temporarily overriding the control loop, which would normally keep the rear magnet array 150.2 pointing straight down.

In FIG. 8E, the vehicle 100 is climbing the wall 820, with both magnet arrays 150.1 and 150.2 directly facing the wall 820. The magnet arrays may stay in these positions until the vehicle 100 reaches the obstacle 830.

FIG. 8F shows an example way of navigating the obstacle 830. In this example, the rear magnet array 150.2 includes an anti-rotation bar 160, which is locked in its deployed condition. Locking may be initiated by the remote operator or automatically, e.g., in response to detecting that the vehicle 100 is tipping backwards. As the vehicle 100 begins to climb over the obstacle 830, the vehicle 100 tips backwards but the anti-rotation bar 160, which extends straight back from the magnet array 150.2, firmly holds the vehicle 100 to the wall 820, such that the vehicle does not fall backwards.

Without the anti-rotation bar 160, the magnet array 150.2 might be unable to resist a peeling force which would result from the vehicle tipping backwards. However, the anti-rotation bar 160 converts what would otherwise be a peeling force into a normal force, which the magnet array 150.2 is able to resist easily. Indeed, in some examples the vehicle 100 could rotate backwards to a completely inverted position, and the magnet array 150.2 could still hold the vehicle firmly to the wall 820. For perspective, in some examples the vehicle 100 weighs only a few pounds but the magnet arrays can pull with over a hundred pounds of force. The anti-rotation bar 160 is thus an indispensable aid in navigating complex obstacles.

FIG. 9 shows an example method 900 of operating a vehicle 100 according to one or more embodiments and provides an overview of some of the features described above. The method 900 may be performed, for example, by the vehicle 100 itself, which may operate autonomously and/or responsive to remote control by a human operator.

At 910, the vehicle 100 drives along a horizontal surface 810 (FIG. 8A) of a ferromagnetic structure with the magnet array 150 (e.g., array 150.1 or array 150.2) facing the horizontal surface 810 and attracting the vehicle 100 to the horizontal surface 810.

At 920, upon the first and second wheels 130 contacting a vertical surface 820 of the ferromagnetic structure, the magnet array 150 is rotated to face the vertical surface 820 (FIG. 8B for array 150.1, or FIG. 8D for array 150.2) and to attract the vehicle to the vertical surface 820.

At 930, the vehicle is driven up the vertical surface 820 with the magnet array continuing to face the vertical surface, e.g., as shown in FIG. 8E.

An improved technique has been described in which a magnet array 150 is controllable to articulate relative to a vehicle 100 such that a downforce from the magnet array 150 can be aimed in a single direction over a wide range of angles, which include an angle aimed below the vehicle 100 and an angle aimed in front of and/or behind the vehicle 100. Advantageously, the improved technique enables the vehicle 100 to handle transitions between different surfaces effectively by controlling the direction of magnetic downforce. Not only can this approach facilitate transitions between floors and walls and between walls and ceilings, but it can also handle transitions among irregular surfaces, including passageways between different tanks or containers.

Having described certain embodiments, numerous alternative embodiments or variations can be made. For instance, although the illustrated examples are shown in the context of a vehicle having four wheels, the same principles apply to vehicles having only two wheels provided the wheels are transversely aligned, such as vehicles designed to balance on two wheels (e.g., Segway® and similar vehicles). In addition, the same principles apply to vehicles having greater than four wheels, such as six-wheeled or eight-wheeled vehicles. Embodiments can also be used in tracked vehicles, such as vehicles that include wheels having tracks that extend in loops around them, e.g., a left track over front and rear left wheels and a right track over front and rear right wheels.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A vehicle for driving on ferromagnetic structures, comprising:
a chassis;
first and second wheels rotatably coupled to the chassis; and
a magnet array coupled to the chassis for magnetically attracting the vehicle to the structures, the magnet array being controllable to aim a magnetic field produced by the magnet array over a range of angles relative to the chassis.

2. The vehicle of claim 1, wherein the magnet array coupled to the chassis is configured to swing about a transverse axis of the chassis that intersects the first and second wheels.

3. The vehicle of claim 2, further comprising an axle that connect the first wheel to the second wheel, wherein the transverse axis is colinear with the axle, such that the first wheel, the second wheel, and the magnet array are all configured to rotate about the axle.

4. The vehicle of claim 2, wherein the magnet array includes a first end disposed within the first wheel and a second end disposed within the second wheel.

5. The vehicle of claim 4, wherein a radial distance between the first end of the magnet array and an outermost radial extent of the first wheel is less than ten millimeters, and wherein a radial distance between the second end of the magnet array and an outermost radial extent of the second wheel is less than ten millimeters.

6. The vehicle of claim 4, further comprising a load cell configured to measure a downforce that results from the magnet array being attracted to the ferromagnetic structures.

7. The vehicle of claim 6, wherein the load cell is attached to the first end of the magnet array and a pin joint is attached to the second end of the magnet array, the pin joint enabling the magnet array to pivot for compressing and expanding the load cell in response to the downforce.

8. The vehicle of claim 6, further comprising a motor configured to rotate the magnet array about the transverse axis independently of the first and second wheels.

9. The vehicle of claim 8, further comprising an electronic control system constructed and arranged to receive the measured downforce from the load cell and to direct the motor to adjust an angle of the magnet array about the transverse axis to maximize the measured downforce.

10. The vehicle of claim 2, wherein the magnet array includes a Halbach array in which multiple individual magnets have respective magnetic orientations.

11. The vehicle of claim 10, wherein the magnet array is an epoxy-potted assembly.

12. The vehicle of claim 2, further comprising an anti-rotation bar constructed and arranged to assume a locked condition in which the anti-rotation bar is locked at a right angle relative to the magnet array and an unlocked condition in which the anti-rotation bar is free to retract into a space between the first and second wheels.

13. The vehicle of claim 12, further comprising a spring constructed and arranged to bias the anti-rotation bar to the locked condition.

14. The vehicle of claim 2, wherein the first and second wheels are disposed at a first end of the vehicle, wherein the vehicle further comprises:
third and fourth wheels disposed at a second end of the vehicle; and
a second magnet array attached to the chassis for magnetically attracting the second end of the vehicle to the structures.

15. A method of operating a vehicle having a chassis, first and second wheels rotatably coupled to the chassis, and a moveable magnet array, the method comprising:
driving the vehicle along a horizontal surface of a ferromagnetic structure with the magnet array facing the horizontal surface and attracting the vehicle to the horizontal surface;
upon the first and second wheels contacting a vertical surface of the ferromagnetic structure, rotating the magnet array to face the vertical surface and to attract the vehicle to the vertical surface; and
driving the vehicle up the vertical surface with the magnet array continuing to face the vertical surface.

16. The method of claim 15, wherein rotating the magnet array to the second position includes operating a motor to swing the magnet array about an axis that intersects the first and second wheels.

17. The method of claim 15, further comprising:
measuring a downforce that results from the magnet array being attracted to the ferromagnetic structure; and
adjusting an angle of the magnet array about the axis to maximize the measured downforce.

18. The method of claim 15, further comprising, while the first and second wheels are in contact with the vertical surface, locking an anti-rotation bar at a right angle to the magnet array such that the anti-rotation bar extends back from the vehicle and resists a backward rotation of the vehicle away from the vertical surface.

19. The method of claim 18, further comprising unlocking the anti-rotation bar to enable the anti-rotation bar to retract into a space between the first and second wheels.

20. The method of claim 15, wherein rotating the magnet array to face the vertical surface includes remotely controlling a motor to rotate the magnet array.
